(19) United States
(12) Patent Application Publication
(10) Pub. No.: US 2004/0217183 A1
(43) Pub. Date: Nov. 4, 2004

(54) Methods and apparatus for cleaning

(76) Inventors: Sang Gyoon Bae, Mesa, AZ (US); Won Sik Park, Mesa, AZ (US); Song Yul Cha, Buffalo Grove, IL (US)

Correspondence Address: Mr. Steven Bae, Green Steam Car Wash, 876 N. McQueen Road, Suite #101, Gilbert, AZ, 85233, US

(21) Appl. No.: 10/423,434

(22) Filed: Apr. 25, 2003

(51) Int. Cl. B05D 1/00

(52) U.S. Cl. 239/8; 239/129; 239/130; 239/135; 239/722

(57) ABSTRACT

The present invention provides a low pressure and low temperature steam cleaner for washing vehicles. A vaporizing unit which vaporizes water at low temperature and low pressure is used to supply steam through a delivery device, such as a wand, to clean a car. The steam supplied is applied to the car, often with various chemicals, to lift and remove dirt and debris. Because the steam is supplied at low temperature and pressure, very little water and/or chemicals are needed, and the propensity of damaging the car's finish is reduced. For similar reasons, one can use the same device to clean the interior of the car (including generally water-averse materials such as fabrics and leather), thus, providing the above described advantages.

### FIELD OF INVENTION

This invention relates generally to methods and apparatus for cleaning, and in particular using low pressure, low temperature steam for cleaning. As will become apparent herein, the present invention is particularly useful for cleaning vehicles such as automobiles.

### BACKGROUND OF THE INVENTION

Numerous machines, equipment and methods for cleaning a variety of items from vehicles and structures have been developed over the years, each attempting to improve on its predecessors in terms of qualities such as efficacy, portability, environmental soundness and other aspects.

For example, conventional “drive-through” car washes typically function in an assembly-line manner in that there are generally a number of different stations within one structure, with each station carrying out a different step on a vehicle as it moves through the structure. For example, a first station pre-rinses or washes the vehicle. A next station might apply a detergent. A following station then uses brushes, cloth or the like to “scrub” the vehicle. Final steps might include a rinse, wax, dry and/or other steps. However, such car washes use large quantities of water and washing aids (soap, wax, etc.). Additionally, such washes must be permanently located; i.e., they cannot be “delivered” to the vehicle to be washed. Further still, the brushes, cloth or other “scrubbers” may have a propensity to damage the finish of the vehicles being washed.

Another method of washing a vehicle is commonly known as a “touch less” car wash. There are generally two types of touch less car washes: stationary (within an enclosure) or a wand type washer. The stationary touch less car wash operates similar to the conventional drive-through car wash in that the vehicle is washed in an enclosure. In such instances, the car is stationary and the water spray, soap, and wax nozzles move around to wash the car without physically moving the vehicle. The second touch less type of car wash is the wand type, typically either found in an enclosure or mobile (e.g., commercially available high pressure power washers). Both of these methods of washing require tremendous amounts of water and, in the case of mobile washers, generally likewise require the transport of large amounts of water with the device itself as in United States Patent Application Pub. No. 2003/001959, or require the vehicle to be washed near a fixed water source, detergent and the like and still present potential harm to the vehicle via high pressures and high temperatures.

Additionally, with respect to both conventional drive-through washes and high pressure wands washes, neither provides the ability to clean vehicle interiors with the same apparatus due to, among other things, the high pressures, temperatures and amounts of water required, as well as the complexity of the machines involved.

Thus, with respect to many known washing methods and equipment, while some disadvantages can be addressed to some extent, in most instances, it is difficult to address all of the numerous disadvantages at one time, and moreover, none of the foregoing methods or equipment provide the ability to minimize environmental impact (as most presently known means use 25 or more gallons of water per wash), to better prevent damage to a vehicle's finish, allow for increased portability, or allow the entire car (including the interior fabrics and moldings, etc.) to be cleaned with the same unit.

Accordingly, there is a long felt need for a washing device (which may or may not be mobile/portable) enabling complete detailing of a vehicle which uses minimal amounts of water and chemicals, that can be used on the entire vehicle and which is not detrimental to the vehicles finish.

### SUMMARY OF THE INVENTION

While the way in which the present invention addresses the disadvantages of the prior art will be discussed in greater detail below, in general, the present invention provides technology which offers significant advantages over prior art washers and methods for using the washers to clean vehicles and structures.

In this regard, briefly, as used herein, “chemicals” is used to generally refer to additives such as soap, wax, rinse aids and the like which may be used when cleaning various vehicles and structures. Likewise, though the term “vehicles” is used often herein to refer to automobiles, the term should be inclusive of a variety of “things” to washed such as structures (houses, buildings, etc.), roads, and non-automobile vehicles (airplanes, motorcycles, etc.). Stated otherwise, “vehicles” should be appreciated to encompass anything in need of washing.

That said, in accordance with the present invention, a low pressure and low temperature steam cleaner (an “LPLT cleaner”) is provided for washing vehicles. For example, a vaporizing unit which vaporizes water at low temperature and low pressure is used to supply steam through a delivery device, such as a wand, to clean a car. The steam supplied is applied to the car, often with various chemicals, to lift and remove dirt and debris. Because the steam is supplied at low temperature and pressure, very little water and/or chemicals are needed, and the propensity of damaging the car's finish is reduced. For similar reasons, one can use the same device to clean the interior of the car (including generally water-averse materials such as fabrics and leather), thus, providing the above described advantages. Likewise, in various embodiments, less than one quarter cup of water is needed to wash one vehicle.

### BRIEF DESCRIPTION OF THE DRAWINGS

The subject matter of the present invention is particularly pointed out and distinctly claimed in the concluding portion of the specification. A more complete understanding of the present invention, however, may best be obtained by referring to the detailed description and claims in connection with the drawing figures, wherein:

FIG. 1 is a perspective view of an LPLT cleaner and vehicle to be cleaned at a specific location in accordance with the present invention; and

FIG. 2 is a flow chart illustrating the steps involved in cleaning a vehicle in accordance with the present invention.

### DETAILED DESCRIPTION

The following description is of exemplary embodiment of the invention only, and is not intended to limit the scope, applicability or configuration of the invention in any way. Rather, the following description is intended to provide a convenient illustration for implementing various embodiments of the invention. As will become apparent, various changes may be made in the function and arrangement of the elements described in these embodiments without departing from the scope of the invention as set forth in the appended claims.

For example, in the context of the present invention the method and apparatus hereof are illustrated using a steam cleaning device such as Steam Zet 5000G steam cleaner manufactured by Yujin S&T and the New Speed 5000 steam cleaner manufactured by Wash Korea or other similar device. However, generally speaking, any number of alternative, now known or as yet unknown devices, having properties equivalent to those described herein may likewise be substituted and still fall within the ambit of the appended claims.

Briefly described, in a preferred embodiment, the present invention overcomes the above-mentioned disadvantages, and meets the recognized need for a low pressure, low temperature steam cleaner (as mentioned above, an “LPLT cleaner”). As used herein, low pressure means a pressure in the range of about 75 psi to about 90 psi (about 5 bars to about 6 bars) and low temperature means about 150 to about 180 degrees Fahrenheit (or about 65 to about 85 degrees Celsius). In accordance with one embodiment of the present invention, the LPLT cleaner has the ability to be mobile to a variety of sites. Briefly, however, one skilled in the art will appreciate that LPLT cleaner may be located at one location; that is, not mobile. In such instances, the vehicle is taken to the permanent location for cleaning.

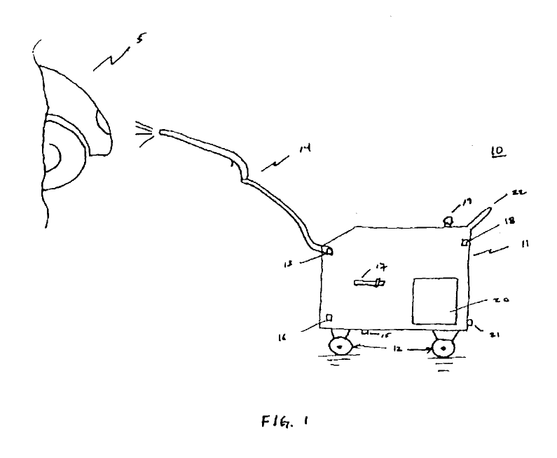

Additionally, various features such as the ability to provide delivery of chemicals (detergent, wax, rinse aids, etc.) via LPLT cleaner are provided. In the presently described exemplary embodiment, and with reference to FIG. 1, LPLT cleaner comprises numerous components which may or may not be present in various embodiments. For example, LPLT cleaner 10 generally comprises a body 11. Body 11 further comprises a set of wheels 12 (or casters or the like) to facilitate the rolling of body 11. Body further comprises a hose connector 13 which allows the connection of a hose and/or wand 14 combination for application of the steam to the article to be washes (as shown, a car 5). Various storage compartments 20 may also be provided which can be used for storing any number of items such as tools and equipment, fuel (e.g., LP gas) for heating water, water and chemical reservoirs and the like. When remote water supplies are used, water supply connectors 21 may be provided. In either case, it may be beneficial to have a drain valve 15 for emptying LPLT cleaner 10 after use.

LPLT cleaner 10 additionally comprises various features for its operation. For example, LPLT cleaner 10 may comprise a variety of switches, gauges and connectors. For example, in the exemplary LPLT cleaner 10 illustrated in FIG. 1, the unit comprises a power connector 16 for plugging cleaner 10 to a power source and a power switch 18 for turning LPLT cleaner 10 ON and OFF.

Any number of additional features may be integrated on LPLT cleaner 10. For example, a power receptacle may be located on the unit for options such as battery charging or powering other devices. There may also be additional reservoir containers for containing different chemicals depending on particular applications. For example, one reservoir may contain water, another detergent and another wax. Thus, through control of dispersion from each reservoir, one can switch from setting such as pure rinsing, soaping, and waxing, while suitably preventing chemicals from mixing.

LPLT cleaner 10 may have various additional or alternative control panels having switches and controls 17 for turning unit on and off, changing temperature and pressure settings, adjusting the flow of the chemicals through LPLT device 10 and numerous other aspects. Similarly, gauges 19 may be provided for monitoring the pressure, temperature and characteristics (such as flow rate) of the unit and exiting steam.

Additionally, safety features such as an emergency stop or “kill switch” may be provided to disengage LPLT cleaner 10 as necessary. LPLT cleaner 10 may also have ergonomic devices such as handles 22 attached to its exterior so that the LPLT cleaner 10 can be easily pushed, pulled, and/or lifted.

In accordance with the present invention, use of the LPLT cleaner provides the ability to meet the objectives and realize advantages relating to using less water, portability, convenience, preservation of vehicle finish, the ability to use LPLT cleaner on the vehicles inside and outside finishes and numerous other advantages.

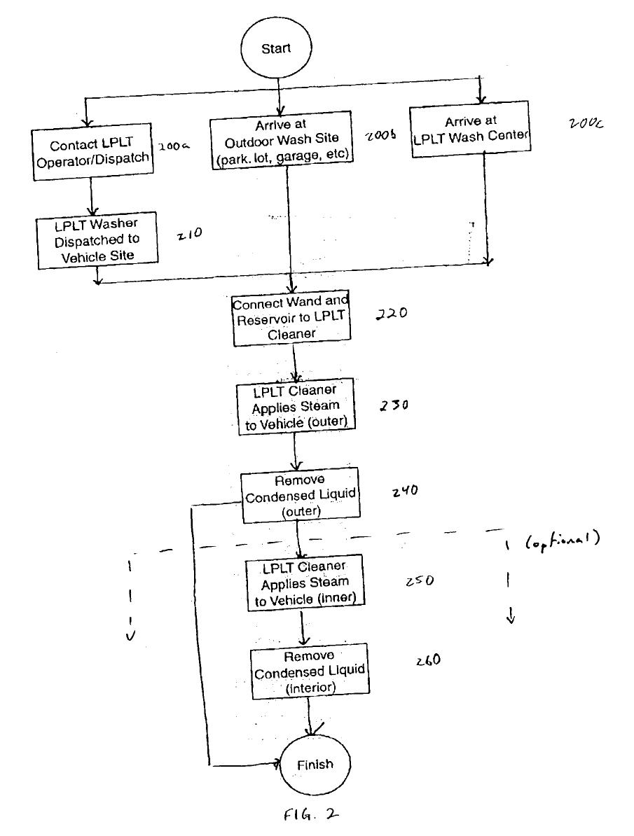

For example, in accordance with one aspect of the present invention and with reference to the flow chart of FIG. 2, a person desirous of having a vehicle cleaned can contact an LPLT operator or dispatch (Step 200a) to provide a location of the vehicle and request the vehicle be washed. Of course, as mentioned above, the person alternatively brings the vehicle to an outdoor wash site (Step 200b) or other permanently located LPLT cleaner station (Step 200c).

An LPLT operator then takes the LPLT cleaner to the vehicle (Step 210) and commences washing the vehicle through a series of steps. For example, the LPLT cleaner suitably comprises a reservoir for containing the water which is vaporized to low pressure, low temperature steam. In its various embodiments, the reservoir may be integrated directly to LPLT cleaner, though, in alternative embodiments, reservoir may comprise a detached, non-integrated reservoir. Additionally, in its various embodiments, the present invention may comprise a reservoir which contains additional components to the water, such as detergent, wax, rinse-aids and/or other chemicals which aid in cleansing the vehicle.

LPLT cleaner suitably further comprises a steam delivery device such as known “wands” found and often used in connection with portable washing devices. Of course one skilled in the art will appreciate that other structure beyond known wands likewise fall within the scope of the present invention, so long as they comprise devices capable of delivering steam, and as such, the present invention and appended claims should not be construed as limited to wands.

The connected reservoir, wand and base unit (e.g., Steam Zet 5000G) (Step 220) thus suitably comprise a completed cleaner system suitably for cleaning the vehicle. Supplying power to the base unit (e.g., through AC, DC or other power supplies) suitably allows vaporization of the contents of the reservoir to begin washing the vehicle. For example, in the presently described embodiment, the contents of reservoir are vaporized to a temperature of about 150 to about 180 degrees Fahrenheit (65 to 85 degrees Celsius) and are preferably expelled from wand at about 70 psi to about 90 psi (5 bars to about 6 bars). This vaporized low pressure, low temperature steam is then applied to the outer surface of the vehicle (Step 230). As the steam comes in contact with the vehicle, it condenses to its liquid state and aids in “lifting” dirt and debris from the surface of the vehicle. The condensed liquid is then removed from the surface of the vehicle, taking the dirt and debris with it (Step 240). For example, the condensed liquid may be removed via absorption such as through towels and/or other porous mediums. Alternatively, forced air may “blow dry” the surfaces. Still further, other alternatives may include “vacuum” of the condensed liquid from the car surface through a negative pressure (suction). In any event, it will be appreciated by one skilled in the art the any number of means may be used to remove the condensed liquid and debris from the surface of the vehicle. Further still, optionally, additional operation can be performed such separate waxing, sealing and/or buffing of the vehicle, shining the tires and other “detailing” may be done.

Additionally, the present invention suitably provides the ability to clean the interior of the vehicle in a substantially seamless transition from cleaning the outer surface. For example, after removing the condensed liquid from the outer surface, one can open the vehicle and apply steam to the inner surfaces in a similar manner as the outer surface to clean (Step 250). Because the liquid vaporized is at a low temperature and low pressure, it is possible to use the same cleaning device at the same settings to clean the interior even in cases where the interior comprises materials not normally subject to cleaning using traditional cleaning devices and methods for the outer surfaces of vehicles. The condensed liquid is again removed, at the same time remove dirt and debris (Step 260).

Thus, given the low pressure and low temperature, an entire cleaning of a typical vehicle can use less than a quarter of a cup of water. Additionally, it should be noted that many of the foregoing steps can be performed in different orders and different manners. For example, an interior of a vehicle can be cleaned first and the exterior last and still fall within the ambit of the present invention. Similarly, it should be appreciated that an entire surface need not be cleaned at one time. For example, it may be advantageous to partition portions of a surface, apply steam, and remove condensation prior to moving on to other portions of a surface. For example, one might first clean the hood of an automobile, then the fenders, the doors and so on. In any regard, it should be appreciated that partitioning falls within the scope of the present invention as well.

Finally, in the foregoing specification, the invention has been described with reference to specific embodiments. However, one of ordinary skill in the art appreciates that various modifications and changes can be made without departing from the scope of the present invention as set forth in the claims below. Accordingly, the specification is to be regarded in an illustrative rather than a restrictive sense, and all such modifications are intended to be included within the scope of the present invention.

Likewise, benefits, other advantages, and solutions to the problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

We claim:

1. A method for cleaning vehicles, comprising:
delivering an LPLT cleaner to a vehicle;
providing a reservoir filled with water;
providing a steam delivery wand;
connecting said steam delivery wand and said reservoir to said LPLT cleaner to form a completed cleaner system;
using completed cleaner system to vaporize water to LPLT steam for application to an outer surface of said vehicle via said steam delivery wand causing said steam to condense to a liquid state on said outer surface;
removing said condensed liquid from said outer surface;
using completed cleaner system to vaporize water to LPLT steam for application to an inner surface of said vehicle via said steam delivery wand causing said steam to condense to a liquid state on said inner surface;
removing said condensed liquid from said inner surface; and
wherein the total amount of said condensed liquid on said outer and inner surfaces is less than about one quarter cup.

2. The method according to claim 1, further comprising adding chemicals to said reservoir.

3. The method according to claim 1, wherein said LPLT steam is about 150 degrees Fahrenheit to about 180 degrees Fahrenheit.

4. The method according to claim 1, wherein said LPLT steam has a pressure of about 70 psi to about 90 psi.

5. The method according to claim 2, wherein said chemicals comprise a detergent.

6. The method according to claim 2, wherein said chemicals comprise a rinse aid.

7. The method according to claim 2, wherein said chemicals comprise a wax.

8. The method according to claim 1, further comprising buffing said vehicle.

9. A method for initiating the cleaning and follow-through on the cleaning of a vehicle, comprising:
receiving a message from a vehicle owner noting a location of a vehicle;
delivering an LPLT cleaner to said location;
providing a reservoir filled with a mixture of water and detergent and a steam delivery wand connected to said LPLT cleaner to form a completed cleaner system;
using completed cleaner system to vaporize said mixture to LPLT steam having a temperature of about 150 degrees Fahrenheit to about 180 degrees Fahrenheit and a pressure of about 70 psi to about 90 psi for application to a portion of an outer surface of said vehicle via said steam delivery wand causing said steam to condense to a liquid state on said outer surface;
removing said condensed liquid from said portion of said outer surface;
using completed cleaner system to vaporize said mixture to LPLT steam for application to an inner surface of said vehicle via said steam delivery wand causing said steam to condense to a liquid state on said inner surface;
removing said condensed liquid from said inner surface; disassembling said completed cleaner system;
wherein the total amount of said condensed liquid on said outer and inner surfaces is less than about one quarter cup; and
leaving said location.

10. A method for cleaning vehicles, comprising:
delivering a vehicle to an LPLT cleaner station having an LPLT cleaner, said LPLT cleaner to comprising a reservoir filled with water and a steam delivery wand,
connecting said steam delivery wand and said reservoir to said LPLT cleaner to form a completed cleaner system;
using completed cleaner system to vaporize water to LPLT steam for application to an outer surface of said vehicle via said steam delivery wand causing said steam to condense to a liquid state on said outer surface;
removing said condensed liquid from said outer surface;
using completed cleaner system to vaporize water to LPLT steam for application to an inner surface of said vehicle via said steam delivery wand causing said steam to condense to a liquid state on said inner surface;
removing said condensed liquid from said inner surface; and
wherein the total amount of said condensed liquid on said outer and inner surfaces is less than about one quarter cup.

11. The method according to claim 10, further comprising adding chemicals to said reservoir.

12. The method according to claim 10, wherein said LPLT steam is about 150 degrees Fahrenheit to about 180 degrees Fahrenheit.

13. The method according to claim 10, wherein said LPLT steam has a pressure of about 5 bars to about 6 bars.

14. The method according to claim 11, wherein said chemicals comprise a detergent.

15. The method according to claim 11, wherein said chemicals comprise a rinse aid.

16. The method according to claim 11, wherein said chemicals comprise a wax.

17. The method according to claim 10, further comprising buffing said vehicle.
